(19) United States
(12) Patent Application Publication
(10) Pub. No.: US 2011/0062349 A1
(43) Pub. Date: Mar. 17, 2011

(54) Cassette and Device for Testing Objects

(75) Inventor: Nils Kah, Remseck (DE)

(73) Assignee: Duerr Not GMBH & Co. KG, Bietigheim-Bissingen (DE)

(21) Appl. No.: 12/989,606

(22) PCT Filed: Mar. 17, 2009
(86) PCT No.: PCT/EP2009/001945

§ 371 Date: Nov. 17, 2010

(30) Foreign Application Priority Data
Apr. 24, 2008 (DE) 102008020611.3

(51) Int. Cl. G01N 21/64; G01J 1/58

(52) U.S. Cl. 250/483.1

(57) ABSTRACT

A cassette for use while testing objects for errors comprises an image storage layer tailored in the shape thereof to match the object surface, said layer comprising a substrate that is transparent to both sides and a phosphorus layer. The cassette is placed over the surface of the work piece and the work piece is irradiated with X-rays from the opposite side. A reading head that can be moved over the image storage layer activates the excited color centers produced in the image storage layer by X-ray radiation, and the fluorescent light so triggered is registered by photodetectors. Using a position signal for the reading head, an irradiated image of the object is thus produced.

### RELATED APPLICATIONS

This application claims the filing benefit of International Patent Application No. PCT/EP2009/001945, filed Mar. 17, 2009, which claims the filing benefit of German Patent Application No. 10 2008 020 611.3 filed Apr. 24, 2008, the contents of both are incorporated herein by reference.

### TECHNICAL FIELD

The invention relates to a cassette and to a device for testing objects.

### BACKGROUND OF THE INVENTION

Testing devices of such a type find application in the non-destructive testing of materials, for example in connection with the inspection of weld seams. Extensive test regions are examined with the known devices in such a way that the radiation-source and the detection instrument are placed in succession above workpiece regions to be tested and then in each instance a partial test image is recorded which is evaluated for flaws. Such a shifting of radiation-source and detection instrument is time-consuming and requires human intervention.

Such testing devices are also used for military purposes, for police tasks and in the security field.

Analogous examination devices also find application in medicine, paediatrics, dental medicine and veterinary medicine. There are also many applications in which human intervention is not possible or is only possible under very difficult conditions.

Examples from materials testing are, for example, workpieces located underwater, for example cables, pipelines and also the so-called risers which in offshore oil wells are used to transport oil from a point situated on the sea bed to a loading station situated on the surface. The risers have to be flexible, in order to be able to give way sometimes during the movements of the sea and in order to be able to accommodate buckling and rolling movements of a tanker or of a loading pontoon that is being used for transporting or temporarily storing the crude oil.

The tubular material from which the risers are manufactured is subjected to strong mechanical influences and must also withstand chemical attacks in the long term. In practice it is a question of multi-layer composite materials consisting of plastic, metal, textile and insulating layers.

Given the frequent alternating loads to which the risers are exposed, it happens that fatigue fractures arise in the course of time. These have to be detected in good time before a leakage of the riser occurs. Leakages of such a type would result in considerable pollutions of the environment and would give rise to production losses which may amount to some millions of Euros per day.

Hitherto there has, for example, been no practicable process for an in-situ examination of the flawlessness of risers, because the cassette with the radiation-sensitive layer has to be brought into a scanner for the purpose of reading out the latent image, necessitating bringing the cassette up out of the water.

Also in other applications it is often difficult to bring the cassette to a scanner after exposure.

The present invention is directed to resolving these and other matters.

### SUMMARY OF THE INVENTION

By virtue of the present invention, therefore, a cassette for use in the radiographic testing of an object is to be specified that can be read out at the place of use.

In accordance with invention this object may be achieved by a cassette for testing an object, using radiation, that is impervious to ambient light and exhibits a wall that is transparent to radiation at least in one region, with a planar light-sensitive recording layer which is arranged in its interior, wherein inside the cassette at least one part of an image-read-out instrument co-operating with the recording layer is arranged which includes: a read-out head, which at a given time co-operates with a partial region of the recording layer, a guide mechanism for the read-out head, a driving mechanism for moving the read-out head on the guide mechanism, and a position-measuring instrument for measuring the position of the read-out head on the guide mechanism.

The cassette according to the invention contains a read-out head and the mechanism for traversing it over the radiation-sensitive recording layer—that is to say, precisely the first part of a scanner, viewed in the signal-processing direction, and just so much that signals reproducing the latent image are obtained.

Since with the cassette according to the invention the recording layer may remain permanently in the cassette for its operational life, the dangers that arise as a result of contact of contaminants with the mechanically sensitive recording layer and as a result of manual handling of the same are also eliminated.

When use is made of the cassette according to the invention, a radiation-source that is used with it for testing can be shifted together with it, region by region, over an extensive object, a procedure that can be undertaken reliably and accurately, since the cassette does not have to be moved completely away from the object between the recordings. Accordingly, an overall image of the object can be generated rapidly and reliably that consists of smoothly combined partial images. One needs only to ascertain, in each instance, via an instrument for measuring the position of the cassette, which partial region of the object is being scanned.

Advantageous further developments of the invention are specified in the dependent claims.

With a further development of the invention it is ensured that the read-out head is always situated opposite the object under comparable conditions.

A further development of the invention is advantageous with regard to simple compact structure and reliable operation of the driving mechanism operating on the read-out head.

In this connection, with the further development of the invention it is guaranteed that the drive means exhibit large stroke and are of compact construction in the direction perpendicular to the direction of motion.

A further development of the invention permits the measurement of the position the read-out head in mechanically simple and space-saving manner.

With a cassette according to a further development of the invention, the measurement of the position of the read-out head can be performed simply and precisely. In this way a plurality of contiguous slit-shaped or strip-shaped partial images are obtained which together reproduce the partial region of the object being monitored.

In a further development of the invention the position of the read-out head can be performed simply by monitoring the application of the control signal for the head-driving mechanism.

In a further development the cassette is advantageous with regard to a rapid gauging of the object. Also with regard to the processing and evaluation of the test image it is advantageous if a line is simultaneously recorded in each instance.

In this connection, a screening of the detection face into pixels can be realised in straightforward manner.

In yet a further development of the invention, a cassette can be realised using semiconductor structural components that are already commercially available for other purposes.

In still a further development of the invention, a cassette, by way of radiation-source use may be made of a radiation-source emitting high-energy photon radiation or corpuscular radiation, and the radiation that has penetrated the object can be converted in straightforward manner into electrical signals, whereby known optoelectronic components may find application.

A further development of the invention permits the read-out of latent images from storage foils that contain metastable colour centres which are capable of being populated by radiation and which then relax as a result of being irradiated with read-out light, accompanied by output of shorter-wave fluorescent light.

In another development of the invention, the cassette is advantageous with regard to the avoidance of radiation damage to the read-out head.

With a cassette according to another embodiment of the invention, on the one hand a rapid read-out of the read-out head is obtained, with good separation of adjacent pixels.

In this connection, with the further development of the invention it is then ensured that no crosstalk occurs between detection elements.

According to a further development of the invention, the fine setting of the testing head within a smaller range of adjustment is measured accurately, the coarse setting less accurately. The partial images that are obtained in the case of successive coarse settings can be placed side by side correctly at the joint by evaluation of overlapping image regions.

With a cassette according to yet another embodiment of the invention, the overall setting of the testing head is composed of an absolute coarse value and a relative fine value.

A cassette according to an embodiment of the invention is particularly well suited for examining pipes and other objects exhibiting circular cross-section.

The further development of the invention permits the read-out head to be constructed to be smaller than 360° in the angular direction and nevertheless permits a continuous test image of a complete ring segment of the object to be obtained by the partial images taken in successive angular increments being joined electronically at the places of overlap.

A cassette according to a further development of the invention is particularly well suited for examining a tubular object rapidly.

With a cassette according to yet another development of the invention, after the read-out of the latent image an erasing of a residual image possibly remaining is effected.

With a cassette according to an embodiment of the invention the erasing unit can also, if necessary, be used as read-out head or as second read-out head for reading out a residual image. The control of the cassette only needs to be reprogrammed; in particular, the direction of motion of the read-out head needs to be reversed where appropriate. This emergency function is a great advantage in particular when a repair of the cassette on the spot is not possible or is only possible with major difficulties and major expenditure of time.

In this connection, with the device of the invention it is guaranteed that the location of the cassette relative to the object in one direction is predetermined by force.

In many cases it is necessary to be able to examine also relatively large objects rapidly. This can be obtained particularly easily by the object being scanned with a plurality of testing heads which each include a radiation-source and a cassette, which together cover the object.

In a further development is advantageous with regard to defined constant irradiation conditions for the testing of the object.

With a further development of the invention it is ensured that the bearing part and the radiation-source borne by it fill out the cross-section of the tubular object only partly, preferentially only to a small extent. This makes it possible to leave the bearing part and the radiation-source permanently inside the tubular object if this is desired. Also, fluid can continue to be conveyed through the tubular object during the time in which the object is being examined.

A further development of the invention is advantageous with regard to a tilt-free guidance of the bearing part in the tubular object.

Furthermore, guide arms constitute, at the same time, means for homogenising the flow in the tubular object.

A further development of the invention is advantageous with regard to a uniform irradiation of a tubular object with test radiation.

A further development of the invention is advantageous with regard to a particularly rapid generation of a test image, since relatively large regions of the object are irradiated simultaneously.

With a device a tubular object can be tested without a radiation-source needing to be brought into the interior of the tubular object.

In this connection, with the further development of the invention it is ensured that flaws that are located in the wall portion of the object facing towards the radiation-source can be discerned electronically from flaws that are located in the wall portion of the object situated in front of the read-out head.

A device as specified in an embodiment of the invention can also be employed in deep water.

The further development of the invention also serves for applicability of the device under high external pressures without the risk of damage or contamination of the read-out head.

The further development facilitates a correct aligning of read-out head and radiation-source if the two are capable of being moved independently of one another.

The further development of the invention permits an entire region of the object to be irradiated simultaneously.

With a device according to an embodiment of the invention, the radiation is moved over the object in the same way as the read-out head. This is also advantageous with regard to a rapid and automatic generation of the test image.

With a device according to yet another embodiment of the invention, the test beam and the read-out head can be moved jointly, which is advantageous for a simple and inexpensive structure of the device. With the device according to still another embodiment of the invention, it is also guaranteed that the test radiation does not reach the read-out head directly. This makes it possible to use sensitive components in the read-out head which could be damaged in the event of exposure to a high dose of test radiation.

In this connection, the phase shift between the motion of the test beam and the motion of the cassette is chosen in such a way that precisely no direct light of the radiation-source reaches the read-out head.

A device according to an embodiment of the invention, use may be made of read-out heads that exhibit radiation-sensitive elements which can withstand the test radiation.

The measure is also ensured that in no case does the test radiation reach the read-out head.

A device according to the invention can fully gauge an object exhibiting very large dimensions by using a testing head exhibiting small dimensions.

The further development of the invention permits a gauging of the position of the testing head on the object independently of zero displacements or of slippage, added up in the course of time, between head-position indicator and object.

In this connection, a device can measure the movements of the testing head with high resolution.

It is to be understood that the aspects and objects of the present invention described above may be combinable and that other advantages and aspects of the present invention will become apparent upon reading the following description of the drawings and detailed description of the invention

### BRIEF DESCRIPTION OF THE DRAWINGS

FIG. 1 a side view of a tanker which has docked at a loading pontoon which is connected via flexible risers to several sources of crude oil situated on the seabed;

FIG. 2 an axial section through a riser testing head as shown in FIG. 1;

FIG. 3 a transverse section through the axial centre of the testing head shown in FIG. 2;

FIG. 4 a top view of the inside of a transducer unit of the testing head according to FIGS. 2 and 3;

FIG. 5 a representation similar to FIG. 4, in which a modified read-out head is shown;

FIG. 6 an axial view of a modified testing head;

FIG. 7 a view similar to FIG. 6, in which a further modified testing head is shown;

FIG. 8 a view similar to FIG. 7, in which, however, a testing head for flat objects is shown;

FIG. 9 an axial view of a multi-head test unit;

FIG. 10 a section through the test unit of FIG. 9 along the section line X-X therein;

FIG. 11 an axial view of a testing head that is capable of being rotated in the angular direction:

FIG. 12 a schematic representation of a coarse-setting sensor;

FIG. 13 a circuit for combining a coarse-setting signal with a fine-setting signal;

FIG. 14 a testing head similar to that in FIG. 6, wherein precautionary measures have been taken in order to protect the read-out head from test radiation;

FIG. 15 a top view of a flat cassette such as can be used for medical purposes; and

FIG. 16 a top view of a modified flat cassette which resembles that according to FIG. 15.

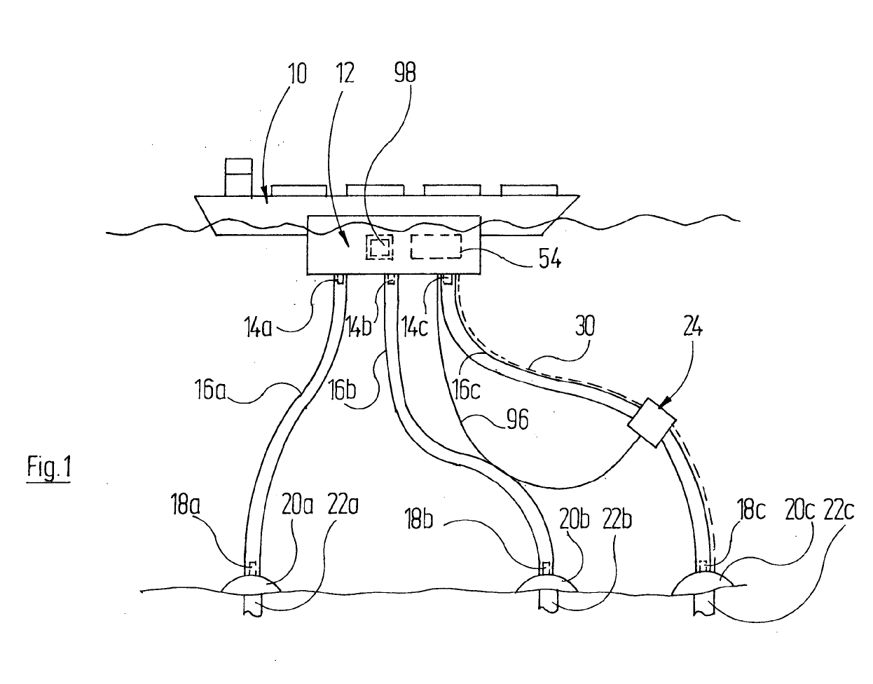

Denoted schematically by 10 in FIG. 1 is a tanker which has moored to a loading pontoon denoted overall by 12. The loading pontoon has supply ports 14a, 14b and 14c which via risers 16a, 16b, and 16c are connected to tapping ports 18a, 18b, 18c which previously pertain to perforated heads 20a, 20b, 20c. From the latter, drill pipes 22a, 22b, 22c go into the rock as far as a deposit of crude oil.

Wherever hereinafter the distinction does not matter, reference symbols 14, 16, 18, 20 and 22 are used without appended letters.

The risers 16 are produced from a composite material that comprises plastic, metal, fabric and insulating layers. The overall composite structure is flexible and pressure-resistant.

In order to be able to test a riser in operation for freedom from flaws, a testing head 24 is provided on this riser 16.

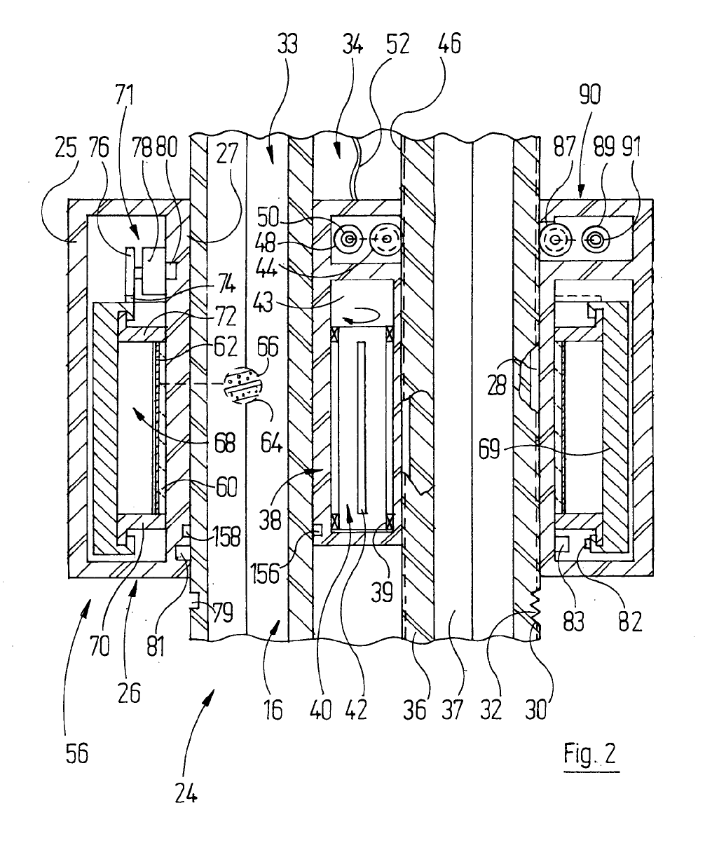

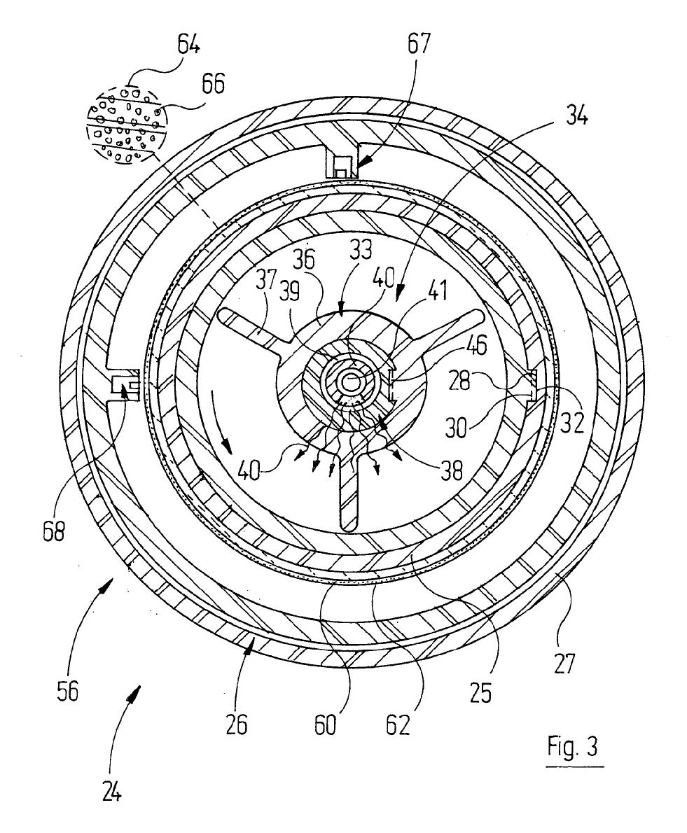

Said testing head has, as shown in more detail in FIGS. 2 and 3, a housing 26 which exhibits an inner cylindrical peripheral wall 27 which is capable of being moved with the housing 26, with sliding clearance, over the external surface of the riser 16, and also an outer cylindrical peripheral wall 25. These form, together with disc-shaped end walls, the pressure-tight and light-tight housing 26. The latter is filled with inert gas under pressure (e.g. nitrogen), the level of the pressure being determined with regard to the external pressure prevailing around the housing. The inner peripheral wall 27 is transparent to X-radiation.

In order to position the testing head 24 by force in the angular direction, the peripheral wall 27 of the housing 26 is provided with an axial positioning groove 28 which co-operates with an axial positioning rib 30 which is provided along a generating line of the riser 16.

In order not to impair the flexibility of the riser 16, the positioning rib 30 may take the form of a toothed rib, the spacing of the teeth 32 being smaller than the axial dimension of the positioning groove 28.

Inside the riser 16 a star-shaped base part 33 of an X-ray head 34 is capable of being displaced with sliding clearance. Via cables which are not shown, or via a rack provided on the inside of the riser 16 and a drive co-operating with said rack on the base part 33, said base part is adjusted in a manner similar to that described further below for the axial adjustment of the X-ray source.

The base part 33 has a sheath-shaped hub part 36 and three radial arms 37 regularly distributed in the peripheral direction. In this manner, interspaces remain between the arms 37, through which, if desired, crude oil can continue to be conveyed from the wellhead 20 to the loading pontoon 12 while the test is ongoing.

Inside the hub part 36 there is located a cylindrical fluid-tight bearing housing 38, in which via bearings 39 a tube housing 40 is supported which receives an X-ray tube 41.

For the purposes of clarification, it is assumed that the X-ray tube 41 is designed in such a way that it generates a cylindrical-sector-shaped radial fan 42 of X-rays.

The tube housing 40 is capable of being rotated about the riser axis by a motor 43, so that the fan 42 revolves.

The upper end of the bearing housing 38 bears a gearwheel 44 running around a transverse axis, which co-operates with a rack 46 which is moulded on the inside of the hub part 36. The drive of the gearwheel 44 is effected by an electric motor 48. A position-indicator 50 is coupled to the axle of the electric motor 48.

Components 44 to 50 together form a head-driving mechanism 51 for the X-ray head 34.

Via a cable 52, which runs through the hub part 36 to the loading pontoon 12, the requisite operating voltage is supplied to the X-ray tube 41, the electric motor 48 is energised, and the signal of the position-indicator 50 is passed to a controller 54 which is likewise accommodated on the loading pontoon 12 and which controls the operations necessary for the examination of the riser 16.

The X-ray head 34 just described forms, together with a cassette 56, the testing head 24.

The cassette 56 will be described in more detail below.

Its housing 26 takes the form of an annular hollow body which runs, with sliding clearance, on the outside of the riser 16, as already stated above.

In the annular interior space of the housing 26 a glass cylinder (or acrylic glass cylinder) 60 is provided which is fixed by press fit on the inner peripheral wall 27 of the housing 26 or is adhesion-bonded or mechanically wedged to the housing 26.

The glass cylinder 60 bears a phosphorus layer 62 on its outside and forms with said layer a storage cylinder 61. The phosphorus layer 62 includes a matrix 64 in which individual finely ground phosphorus particles 66 are homogeneously distributed.

The phosphorus particles 66 are obtained by grinding a solid material that contains colour centres or storage centres. In this connection it is a question of defects which may have metastable excited electron states. If an X-ray quantum impinges on such a storage centre, an electron of the storage centre can be energised into such a metastable excited state in which it then remains for a relatively long time (typically up to 20 minutes and more).

In the course of revolving about the axis of the riser 16, the X-radiation fan 40 consequently generates an image of a cylindrical portion of the riser 16 in the phosphorus layer 62.

Since all the parts of the testing device (with the exception of the phosphorus layer 62), in particular the base part 33 and the housing 26, is produced from a material that is transparent to X-rays (e.g. plastic material or metal with a low atomic number), the annular wall portion of the riser 16, at which the X-ray head 34 stands, is irradiated uniformly with X-ray light of the rotating radiation fan.

The X-ray light that has passed through the wall of the riser penetrates the glass cylinder 60 and impinges on the phosphorus layer 62 where it excites storage centres. This excitation is uniform if the wall of the riser is flawless.

But if the wall of the riser contains flaws, the density of the excited storage centres is locally variable, and the differently excited storage centres represent a latent radiograph of the riser 16.

In order to be able to read out the latent radiograph, an axially aligned slat-shaped read-out head 68 is arranged in the annular space of the housing 26. Said read-out head is borne by a carriage case 69. The latter, in turn, runs on two axially spaced guide rails 70, 72 and bears on its upper side a ring of teeth 74.

The teeth 74 mesh with a pinion 76 which is driven by a stepping motor 78 with angle-indicator 80, which is borne by the housing 26. The angular position of the read-out head 68 can also be ascertained by counting the control pulses that are transmitted to the stepping motor 78.

Components 74 to 80 together form a head-driving mechanism 71.

The angle-indicator 80 is set to zero if a reference mark 82, which is fitted to the lower inner edge of the carriage case 69, is detected by a light barrier 83 operating in reflection, which is provided at the lower end of the housing 26.

In this manner the absolute position of the read-out head 68 in the angular direction is known.

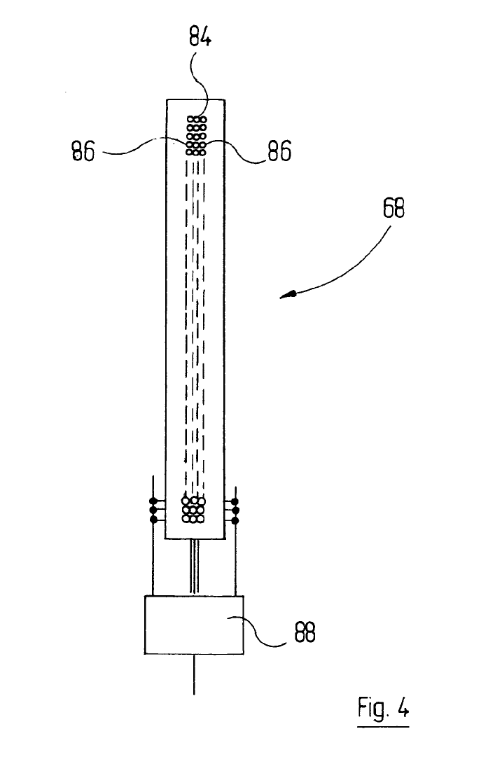

The read-out head 68 exhibits a plurality of detector elements densely arranged along an axially parallel line, which each include an LED 84 and one or two photodiodes 86 closely adjacent to said LED, as evident from FIG. 4.

The LEDs 84 emit in the red, and by the light emitted by an LED the point of the phosphorus layer 62 that is situated directly ahead of it is irradiated.

The LEDs 84 and the photodiodes 86 are embedded in a material that in volume is black and opaque—that is to say, read-out light generated by the LEDs and blue fluorescent light absorbed equally. By this means, only the fluorescent light is received by each photodiode that was released by the LED assigned to it.

If excited storage centres are located in this punctiform region, the electrons located there are raised to a higher level which relaxes, accompanied by emission of blue fluorescent light. This fluorescent light is registered by the adjacent photodiode 86.

In order to accelerate the read-out of the latent test image from the phosphorus layer 62, the LEDs 84 and the photodiodes 86 can each be activated simultaneously if these are very closely adjacent to one another and the directional characteristics of light-emitting diode and photodiode are very narrow lobes.

If it is established that an LED 84 is also still reaching spaced points of the phosphorus layer 62 with appreciable intensity, so that the read-out of the latent image at one image point results in the emptying of storage centres at other image points, the LEDs 84 are combined into groups of interleaved diode sets in such a manner that the LEDs adjacent to one LED and the photodiodes thereof, in which there would be a crosstalk of read-out light of light-emitting diodes not pertaining to them, are in each instance not activated.

In practice, all the diodes can, for example, be combined that are distant from one another by three separations of the detection elements. There are then altogether three sets of LEDs 84 and photodiodes 86, of which the diodes of one set can be read out jointly without crosstalk while the various sets of detection elements are read out in succession.

The combining of the interleaved pixel signals obtained in succession in this way is effected by an evaluating circuit 88 which receives the entire output signals of the photodiodes 86.

By the stepping motor 78 being excited, the various axial image lines are read out in succession that together yield a test image of the annular wall portion of the riser 16, with which the testing head 24 is co-operating.

Viewed in the direction of rotation, downstream of the read-out head 68 an axially aligned slat-shaped erasing unit 67 is fitted to the carriage case 69. Said erasing unit may in practice have the same structure as the read-out head 68, but normally it is operated differently: all the LEDs 84 are operated permanently. By means of the red light generated by said LEDs, storage centres that have not relaxed upon read-out, for instance, are emptied. This is effected securely, since by virtue of the erasing unit 67 the exposure-time is greater by a factor than that the read-out head 68, which corresponds to the number of LEDs.

After the erasing of the residual image, the testing head 24 can be placed axially over a new region of the object surface which overlaps somewhat with the region just measured.

The traversing of the cassette 56 is effected by a cassette-driving mechanism 90 which includes a gearwheel 87, meshing with the teeth 32 and supported in the housing 26, and a stepping motor 89 operating on said gearwheel, with angle-indicator 91. As also for the other angle-indicators, it is to be assumed that a counter is integrated into the angle-indicator, so that an unambiguous position signal for the detection head is obtained over the entire length of the riser 16.

The traversing of the cassette 56 is concluded if a predetermined output signal of the angle-indicator 91 is received.

The traversing of the X-ray head 34 by the same distance is effected analogously.

Alternatively, on account of its identical structure to the read-out head 68, the erasing unit 67 can also be used to read out the latent residual image of the storage disc. In this manner a further, weaker test image is obtained, in which only major flaws in the riser wall are reflected.

If the read-out head 68 fails—for example, as a result of failure of photodiodes—the erasing unit 69 can be used as a transducer unit, and the read-out head 68 can be employed as an erasing unit, in which case only their LEDs are activated. For this purpose, only the direction of rotation of the stepping motor 78 has to be reversed and the programming of the drive of the read-out head 68 and of the erasing unit 67 has to be transposed.

Again alternatively, use may be made of an erasing unit 67 in which only LEDs are provided and the photodiodes have been omitted or replaced by further LEDs.

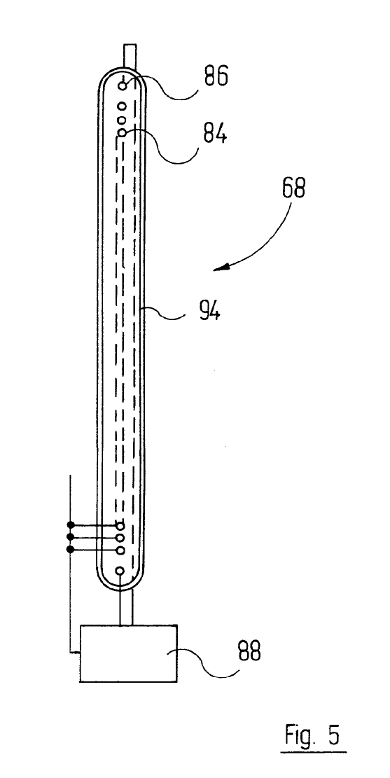

In modification, use may also be made of a read-out head 68 such as is shown in FIG. 5.

With this read-out head, the individually addressable LEDs 84 are embedded in closely spaced manner in a transparent slat which at its ends is provided with parabolic caps 92. Except at the points situated in front of the LEDs 84, the slat is provided continuously with a reflective layer 94, for example by vapour deposition of Al, Ag, Au. The material of the slat may have been dyed in its volume in such a way that it allows fluorescent light to pass through in substantially lossless manner but on the other hand absorbs the light generated by the LEDs 84.

With this read-out head the LEDs 84 are activated individually and the detection of the fluorescent light is effected by only two photodiodes 86 which are located at the focal points of the two slat caps. The position of the image pixel just read out results from the angular position of the read-out head 68, from the number of the LED 84 just activated, and from the output signal of the head-position indicator 80.

This variant enables a high resolution with high sensitivity.

If an annular wall portion of the riser 16 has been examined as described above, the cassette 56 and the X-ray head 34 are moved, by corresponding excitation of their driving motors 78, 89, by a distance in the axial direction that is somewhat smaller than the axial dimension of the fan 42, of the phosphorus layer 62 and of the read-out head 68. Then the recording is effected of a further annular region of the riser 16, as described above.

The various partial test images that are obtained in this way are passed to the controller 54, together with the position signals for the X-ray head 34 and the cassette 56, via the cable 52 and a cable 96 which leads from the cassette 56 to the controller 54 of the loading pontoon 12. Said controller can then combine the axially somewhat overlapping partial test images of the riser 16 to form an overall test image.

This test image can then be represented on a monitor 98, in order to enable a visual inspection of the riser 16. But alternatively the overall test image may also be evaluated for flaws with image-evaluation software, the flaws can be categorised, and the position and type of the flaws can be output in the form of a list.

In the exemplary embodiment described above, only a relative movement of the testing head 24 in relation to the riser 16 is necessary, namely an axial relative movement. Even without image-splitting, a smooth image of the object in the peripheral direction is obtained. But the testing head may be removed only via one end of a riser (as a rule, the upper end), which for this purpose has to be released.

The further exemplary embodiments show testing heads that without releasing a riser can be fitted to the riser and can be dismantled from the latter.

FIG. 6 shows a modified exemplary embodiment in which the cassette 56 extends only over an angular range of 140°. Parts of the cassette 56 that correspond functionally to components elucidated above with reference to FIGS. 1 to 5 are again provided with the same reference symbols, even if they differ in details. These components also do not need to be described again in detailed manner below.

In the exemplary embodiment according to FIG. 6 a toothed belt 100 which runs over two deflecting rollers 102, 104 serves for moving the read-out head 68. Of these deflecting rollers, deflecting roller 104 is driven by the stepping motor 78.

The guide rails 70, 72 are formed as box sections which have a longitudinal slot on the side facing towards the toothed belt. Through this slot, T-shaped guide lugs 100 of the toothed belt 101 engage in the guide rails 70, 72, so that the toothed belt runs along the circular-arc-shaped guide rails 70, 72, positively guided in both strands.

The glass cylinder 60 bearing a phosphorus layer 62 is replaced in the embodiment according to FIG. 6 by an image-storage disc which exhibits a flexible transparent substrate 60 which and bears a phosphorus layer 62. The phosphorus layer 62 is again arranged on the outside of the substrate 60.

The testing head 24 according to FIG. 6 generates in each instance a partial test image which registers somewhat more than 120° of the peripheral extent, for example 126°.

If use is made of the testing head 24 shown in FIG. 6, then by placing said testing head upstream of the riser 16 three times in angular positions that are offset 120° in relation to one another a full image of an annular portion of the riser 16 can again be generated.

The shifting of the testing head 24 in the peripheral direction may be effected in such a way that the testing head 24 is rotatably supported on a frame such as will be elucidated later still more precisely with reference to FIG. 11.

The fixing of the cassette 56 on the riser 16 in the position that has been set in the given case is effected, for example, by jaws 108 which co-operate with the outer surface of the riser 16 and are actuated by working cylinders 114 via elbow levers 110 which are rotatable about bolts 112 borne by a frame 106.

A testing head such as is shown in FIG. 6 can be fitted particularly easily to a riser 16 or dismantled from it without one end (as a rule, the upper end) of the riser having to be set free. The jaws 108 only have to be swivelled away, and then the testing head 24 can be removed from the riser 16 or attached to it in the transverse direction.

For this attaching or dismantling, the housing 26 of the cassette 56 does not need to be opened, which would involve the risk of the penetration of contaminants.

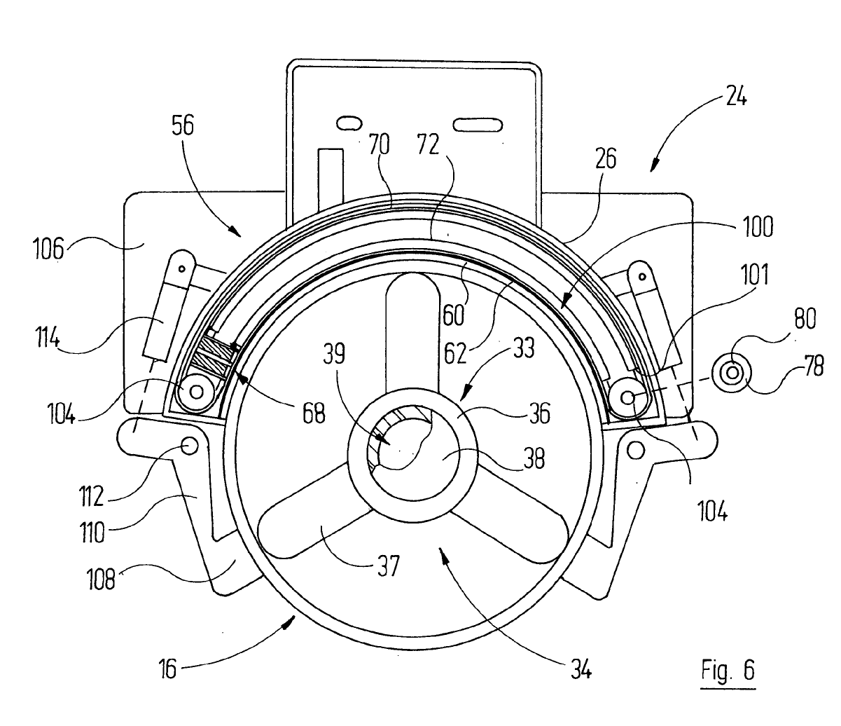

The exemplary embodiment according to FIG. 7 differs from the exemplary embodiment according to FIG. 6 by virtue of the fact that the X-ray head 34 is arranged outside the riser 16. It is seated on a bent bracket 118 which is connected to the frame 106 in articulated manner by a bolt 117, and in the working position shown in the drawing is capable of being locked mechanically or hydraulically.

The irradiation of the riser 16 is consequently effected from the outside, specifically from a point that is located opposite the cassette 56. In this connection the conditions are chosen in such a way that the spacing between the X-ray tube 41 and the adjacent generating line of the wall of the riser 16 is considerably smaller than the spacing between the X-ray tube 41 and the opposite generating line of the wall of the riser 16.

Two test images are now made in two positions of the testing head 58 in relation to the riser 16 that are not situated far apart in terms of angular measurement (for example)10°. By reason of the differing projection conditions, the images of those flaws which stem from the wall portion of the riser 16 facing away from the X-ray tube will be changed less than the shadows of those wall flaws which are located in the portion of the wall of the riser 16 adjacent to the X-ray tube. If the two partial images are compared, the flaws in the front wall portion can be distinguished from the flaws in the rear wall portion.

For the purpose of recording the two test images, also only the X-ray head 34 may be relocated. For this purpose, one arm of the bracket 118 may be divided and may be capable of being changed in length by means of a hydraulic cylinder 119.

This distinction of the flaws in the front and rear walls can be effected automatically by the two partial images being transmitted via a change-over switch 120 into two different memories or memory areas 122, 124 and by the contents of these memory areas being separated from one another with appropriate image-evaluation software in an editing circuit 126.

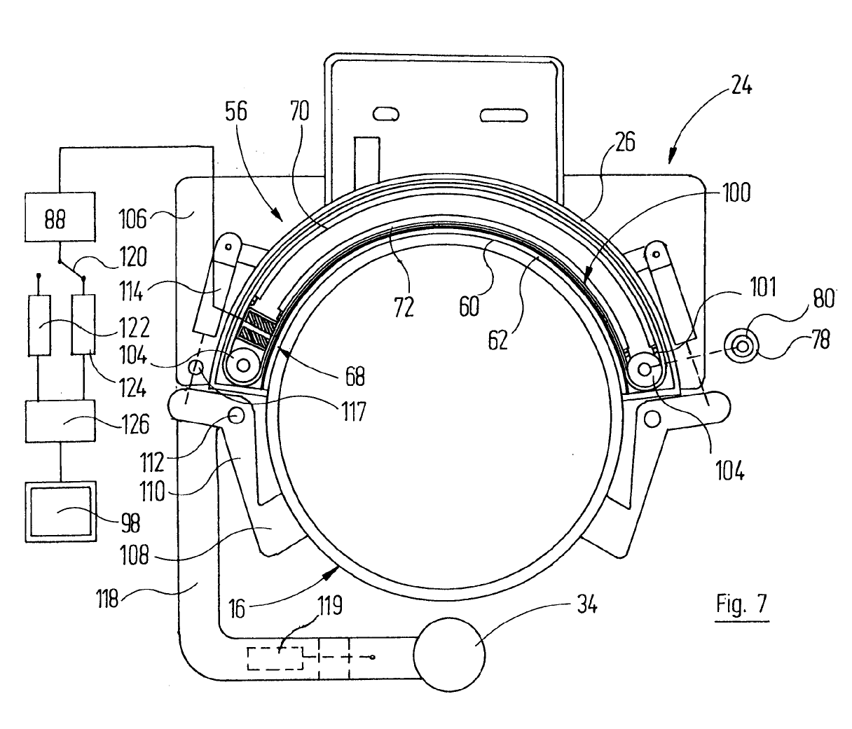

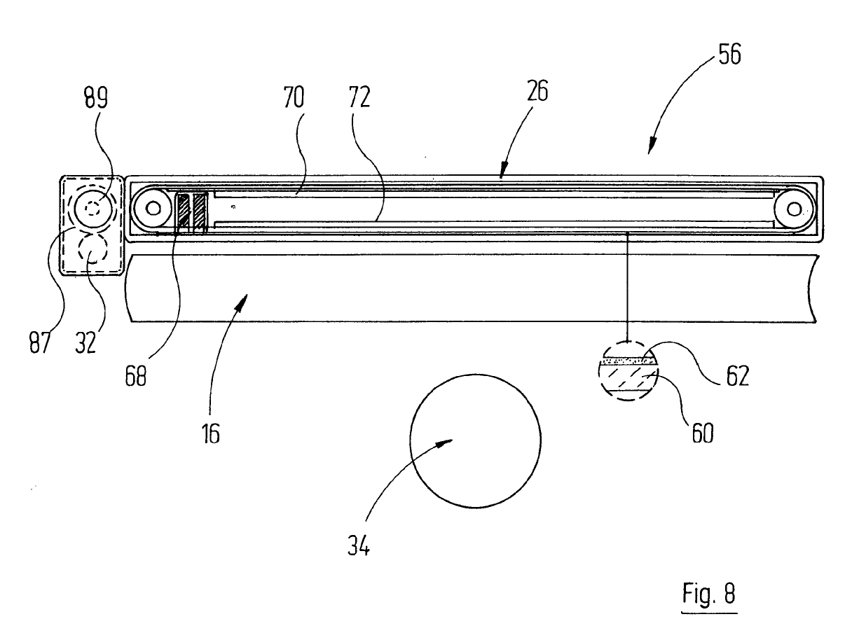

The exemplary embodiment according to FIG. 8 relates to a testing device for a flat object 16. In principle, the structure is similar to that in the case of the exemplary embodiment according to FIG. 7, only the guide rails 70 and 72 are straight and the stepping motor 89 operates via a worm wheel 87 on a rack 32 in order to bring about the feed of the transducer unit 68 in the perpendicular direction in relation to the plane of the drawing.

In the exemplary embodiment according to FIG. 6 there was provision that the same cassette 56 is attached to the riser 16 at three places that are offset in relation to one another by 120°.

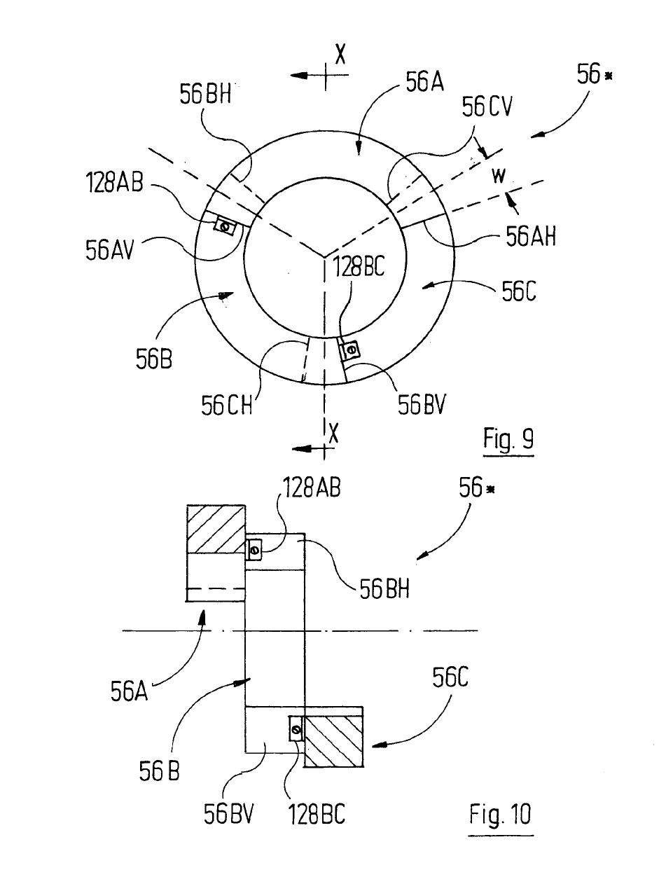

Alternatively, three cassettes 56 as were shown in FIG. 6, can also be releasably connected to a multiple cassette head 56*, offset by 120° in differing axial positions, as shown in FIGS. 9 and 10. It is then sufficient to move the multiple cassette head 56* in a permanent angular orientation along the riser 16, it being possible for this to be effected again with a positioning groove 28 on the cassette head 56* and with a positioning rib 30 on the riser 16.

Shown in FIGS. 9 and 10 are the three cassettes 56A, 56B and 56C; their fronts are denoted respectively by V56A etc.; their rears are denoted by S56A etc. Releasable connections between the individual cassettes are denoted by 128AB and 128BC, respectively.

Dashed radial rays R are exactly 120° distant from one another. It can be discerned that the fronts and rears of the cassettes 56 lay in each instance ahead of and behind, respectively, a radial ray by an angle w, so that consecutive cassettes overlap, in each instance, by an angle 2w. In the exemplary embodiment shown, w amounts to 10°.

For each of the cassettes 56A, 56B and 56C an X-ray source 34 located opposite said cassette is provided, which in the drawing has been omitted for the sake of clarity.

The controller 54 then combines the various partial images that the cassettes 56A, 56B and 56C supply, in such a way that altogether an overall test image of the riser is obtained. For this purpose, in each instance a current partial image of the first testing head, the partial image of the second testing head in the preceding cycle and the partial image of the third testing head in the antepenultimate test cycle are assembled to form a continuous smooth annular image.

In all the exemplary embodiments, the housing 26 of the cassette 56 and the bearing housing 38 of the X-ray head 34 have internal pressure applied to them, preferably with inert gas under high pressure. In this connection the setting of the pressure can be effected as a function of the depth of the water, which in the case of substantially known course of the riser 16 can be derived from the position signal for the testing head 24.

FIG. 11 shows a single cassette 56 with 140° extent, which is rotatably arranged on a frame 106. The latter comprises two frame parts 106A and 106B connected by a joint 130, which are releasably held by a screw coupling 132 in a working position in which the frame 106 surrounds a riser 16 with clearance and is releasably fixed to said riser by jaws (shown in FIG. 11), similarly as described above with reference to FIG. 6 or 7.

By virtue of the fact that the cassette 56 is set three times in angular positions offset 120° in relation to one another with axial position unchanged, a full image of an annular portion of the riser 16 is again obtained.

The angular shifting of the cassette 56 in the peripheral direction is effected in such a way that it is arranged on a split ring 134 which is provided with an external toothed rim 136 and which co-operates with a driven pinion 138 of a driving motor 140 which is equipped with an angle-indicator 142. By the output signal of the angle-indicator 142 being monitored, the detection head 24 can be automatically moved successively into the three working positions offset by 120°.

On the front of the frame 106 there are located four bearing rollers 141 at equal distance from the riser axis and remote from one another at 90° angular distance bearing rollers 138, which support the ring 134 on the periphery.

If it is desired to remove the testing head 24 shown in FIG. 11 from the riser 16, the screw coupling 132 is loosened; similarly, screw couplings 144 holding the ring halves together. After frame part 106A has been swivelled away, the testing head 24 can then be removed in the transverse direction.

According to FIG. 12, combined marks 79, 82 and combined sensors 81, 83 can also be used for the purpose of position measurement.

The combined marks include—in addition to an optical mark 146 exhibiting small dimensions, which, for example, may be a reflecting mark—a transponder mark 148 from which information that reflects the absolute position of the mark 146 can be retrieved in wireless manner.

The combined sensors 81, 83 include an optical sensor 150—for example, a light barrier operating in reflection—and a transponder sensor 152 which reads out in wireless manner the information stored in the transponder mark 148. Components 148 and 152 may be, for example, Temic(R) components.

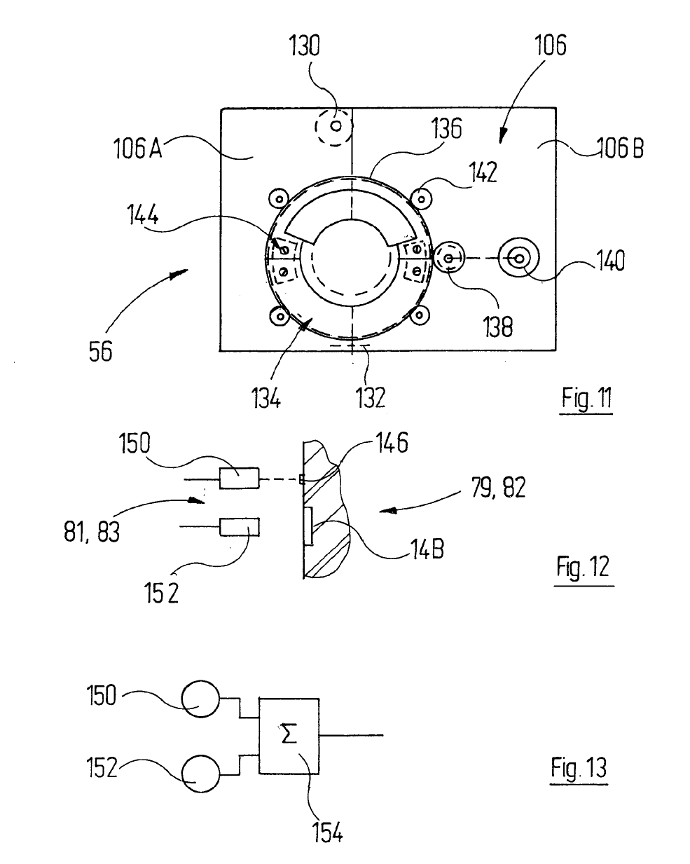

The output signals of a combined sensor consequently permit accurately and absolutely determined coarse positions of the testing head 24 on the riser 16 or of the transducer element 68 on the guide rails 70, 72 to be detected. Movements beyond these predetermined locations are measured by the fine-position indicators 80 and 91. The absolute overall position results as the sum of coarse position and fine position. An appropriate circuit containing an adder 154 is shown in FIG. 13.

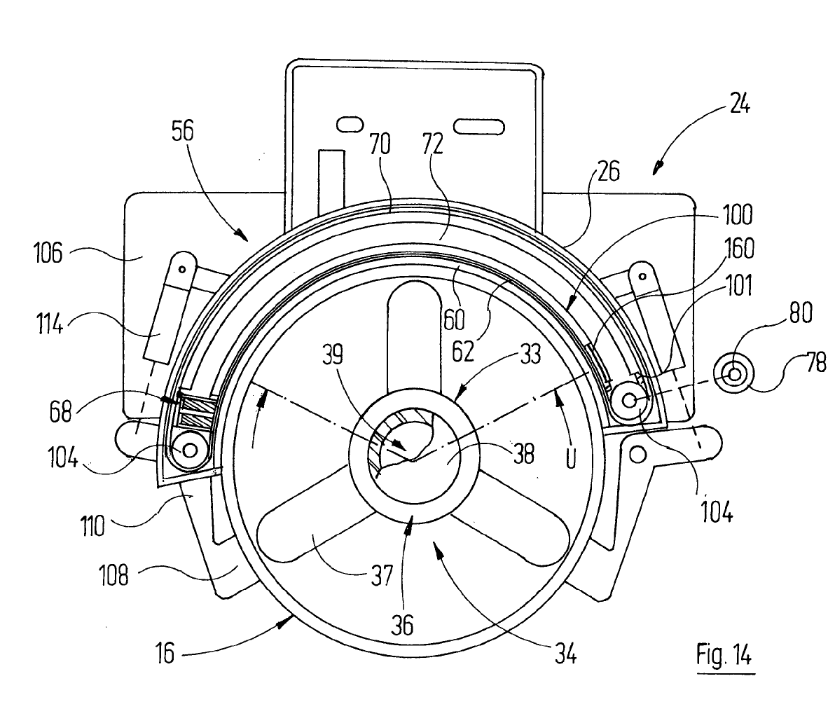

In the case of the testing head 24 shown in FIG. 14, which are very similar to that according to FIG. 6, measures have been taken in order to avoid an irradiation of the read-out head 68 with X-ray light. Hence the read-out head 68 may also include sensitive electronic components.

One possibility shown in the left half of FIG. 14 consists in leading out the guide rails 70, 72 in a direction beyond the angular range denoted by U that is swept by the X-ray light.

One possibility shown in the right half of FIG. 14 consists in providing in a protective position for the read-out head 68—which here has been chosen, for example, at the right end of the stroke—a movable shield 160 which can optionally be placed in front of the transducer unit 68 or can be moved into a parked position releasing said transducer unit.

Where cassette and radiation head are capable of being moved independently of one another, between the two a further sensor device may have been provided, in order to align both heads with one another axially and, where appropriate, also in the peripheral direction. Such a sensor device may include, according to FIG. 2, for example a weakly radioactive sample 156 on the tube housing 40, which emits gamma rays via a pinhole diaphragm, and a small gamma-ray detector 158 which is arranged in the radially inner peripheral wall of the housing 26. The precise juxtaposition of the two heads is obtained when the output signal of the gamma-ray detector 158 has attained a maximum. The juxtaposition obtained in such a way will, as a rule, be more precise than the setting of identical absolute positions for X-ray head and cassette.

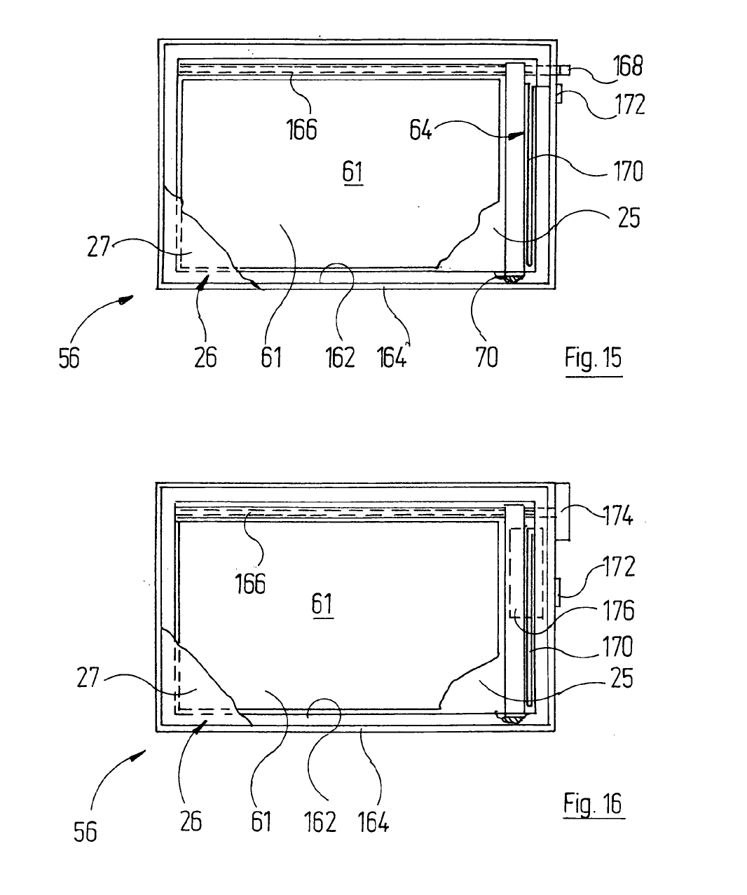

FIG. 15 shows a cassette 56 that can be used for medical purposes. Components of the cassette that correspond in terms of function to cassette parts already described are again provided with the same reference symbols, even if they differ in particulars.

Onto a shoulder 162 of a peripheral frame 164 which is rectangular in top view a window 27 that is transparent to X-radiation but opaque to ambient light is mounted in flush and light-tight manner. The rear of the cassette constitutes a wall 25 that does let light through.

The read-out head 68 is driven by a threaded spindle 166 which extends in parallel manner over the upper longitudinal edge of a storage foil 61. Said spindle is accordingly unable to cast a shadow onto the storage foil.

An end portion 168 of the threaded spindle 166 provided with a squared end is guided outwards through the frame 164.

The read-out head 68 is connected by a hinged cable 170 to a plug-connector part 172 borne by the frame 164.

By attaching its instrument with a mechanical coupling part fitting the end portion 168 and with an electrical coupling part fitting the plug-connector part 172, the prerequisites can consequently be completed that are necessary in order to read out the latent image of the storage foil 61. For this purpose this instrument contains a driving motor and electronic image-recording and image-processing hardware.

The cassette 56 of FIG. 16 corresponds largely to that of FIG. 15, only the end of the threaded spindle is directly connected to a driving motor 174. Also arranged inside the cassette 56 is an image-recording and image-evaluating unit 176 which on the output side is connected to the plug-connector part 172. With this cassette, recorded images can be transmitted as a whole to a PC or memory stick linked to the plug-connector part 172.

In the exemplary embodiments described above, the illumination of the object was effected by X-radiation. Instead of this, use may also be made of radioactive emitters which emit electromagnetic radiation or particles that can generate, directly or indirectly, a latent radiograph in a phosphorus layer.

Sound, in particular ultrasound, may also be radiation in the sense of the claims and the foregoing description.

Instead of using a phosphorus layer, the radiograph can also be registered by a scintillation layer in combination with a photoelectric detector (e.g. a CCD).

For the purpose of better representation, various parts of the device have been represented as integral parts. It will be understood that a person skilled in the art can assemble these, where appropriate, from several separately produced parts.

Parts made of plastic material have been reproduced in alternating cross-hatching (single stroke and double strokes alternate); for light-transparent parts, in dashed cross-hatching.

All the parts of the testing head and of the receptacle for the X-ray source (the latter with the exception of shields that are necessary for reasons of radiation shielding) are produced from material that is highly transparent to X-ray light.

The movement of the testing head along the riser and, where appropriate, in the peripheral direction of the riser may also be effected by cables or even by propeller propulsion or jet propulsion.

The base part 33 may also have been moulded onto the inside of the riser 16. The movement of the X-ray head 34 is then effected completely via the rack 46.

Various relative movements were mentioned implicitly above, for example the movement the read-out head 68 with respect to the phosphorus layer 62. It will be understood that here, in each instance, the concepts ‘moving part’ and ‘stationary part’ may be interchanged.

Furthermore, various position-indicators and drives were mentioned above which exhibit a moving part and a stationary part, for example marks and sensors co-operating with said sensors. It will be understood that these indicator parts and drive parts may be interchanged.

By way of radiation-source, an X-ray source was assumed above that makes a fan-shaped beam available which then had to be moved over the object. Alternatively, particularly in the case of the transirradiation of pipes and other elongated objects, use may be made of a radiation-source with cylindrical characteristic (rotating emitter). Sources of X-rays of such a type have, for example, an anode with conically rotationally symmetrical tip. Radioactive emitters are already naturally omnidirectional. With radiation-sources of such a type, more often than not a rotation of the source can be dispensed with, unless by the rotation it is desired to compensate for irregularities in the radiation characteristic.

It is to be understood that additional embodiments of the present invention described herein may be contemplated by one of ordinary skill in the art and that the scope of the present invention is not limited to the embodiments disclosed. While specific embodiments of the present invention have been illustrated and described, numerous modifications come to mind without significantly departing from the spirit of the invention, and the scope of protection is only limited by the scope of the accompanying claims.

1. A cassette for testing an object, using radiation, using radiation, that is impervious to ambient light and exhibits a wall that is transparent to radiation at least in one region, with a planar light-sensitive recording layer which is arranged in its interior, comprising: inside of the cassette at least one part of an image-read-out instrument co-operating with the recording layer is arranged which includes: a read-out head, which at a given time co-operates with a partial region of the recording layer, a guide mechanism for the read-out head, a driving mechanism for moving the read-out head on the guide mechanism, and a position-measuring instrument for measuring a position of the read-out head on the guide mechanism.

2. The cassette of claim 1, wherein the guide mechanism exhibits at least one guide means which follows a surface of the object at a substantially constant distance.

3. The cassette of claim 1, wherein the head-driving mechanism exhibits a flexible drive means.

4. The cassette of claim 3, wherein the flexible drive means is endless and revolves via deflection rollers.

5. The cassette of claim 3, wherein the head-position measuring instrument co-operates with the head-driving mechanism.

6. The cassette of claim 1, wherein the head-driving mechanism moves the read-out head incrementally on the guide mechanism.

7. The cassette of claim 6, wherein the head-position measuring instrument exhibits a counting mechanism for counting a displacement increments generated by the head-driving mechanism.

8. The cassette of claim 1, wherein the read-out head exhibits a slit-like or strip-shaped detection face.

9. The cassette of claim 8, wherein the read-out head exhibits discrete detection elements arranged on a line.

10. The cassette of claim 9, wherein the detection elements include semiconductor sensor elements.

11. The cassette of claim 9, wherein the recording layer is a phosphorus layer and the sensors are sensors responding to light.

12. The cassette of claim 1, wherein detection elements each exhibit a luminous element and at least one light-sensitive element.

13. The cassette of claim 1, further comprising: a neutral position for the read-out head, in which the latter is not reached by radiation.

14. The cassette of claim 13, wherein the neutral position is arranged outside an edge contour of the wall or exhibits a shield that holds back radiation and is capable of being placed in front of the read head.

15. The cassette of claim 12, wherein the detection elements are subdivided into interleaved groups of detection elements not directly adjacent to one another and the detection elements of a group are activated simultaneously.

16. The cassette of claim 15, wherein the spacing of the detection elements of a group is chosen in such a way that no crosstalk of read-out light between detection elements of the group is obtained.

17. The cassette of claim 1, wherein the head-position measuring instrument exhibits a coarse-position sensor which co-operates with marks, which are moved together with the read-out head, and a fine-position sensor, which co-operates with the read-out head.

18. The cassette of claim 17, wherein an adding circuit is provided which combines the output signal of the coarse-position sensor and the output signal of the fine-position sensor to form an overall position signal.

19. The cassette of claim 1, wherein the guide mechanism is circular-arc-shaped or circular.

20. The cassette of claim 19, wherein an angular extent of the guide mechanism is somewhat larger, for example approximately 10° to approximately 30° larger, preferentially approximately 20° larger, than corresponds to an even submultiple of 360°.

21. The cassette of claim 20, wherein the guide mechanism is circular and exhibits a bearing part for the read-out head, which co-operates with a head-driving motor either via a toothed rim or by frictional engagement.

22. The cassette of claim 1, further comprising: an erasing unit which is moved in phase-shifted manner synchronously with the read-out head.

23. The cassette of claim 22, wherein the erasing unit exhibits the same structure as the read-out head.

24. A device for testing objects, with a radiation-source and with a cassette containing a radiation-sensitive recording layer, which in at least one direction has a smaller dimension than the object, wherein the surface of the object exhibits a guide means extending in the at least one direction, with which cassette and/or radiation-source co-operate(s).

25. The device of claim 24, further comprising: a plurality of cassettes which together cover one of a principal dimensions of the surface of the object and which are guided, offset in relation to one another, in the principal-dimension direction.

26. The device of claim 24 further comprising: a bearing part for the radiation-source, which runs with sliding clearance on a face of the object facing away from the read-out head.

27. The device of claim 26, wherein the bearing part exhibits guide arms, the ends of which co-operate with the surface of the object.

28. The device of claim 27 for use on a tubular object, characterised in that the guide arms have an axial extent that is greater than their radial extent.

29. The device of claim 28, wherein the guide arms (37) are of plate-shaped design and are situated substantially in radial planes.

30. The device of claim 29, wherein the bearing part is tubular and the radiation-source is arranged in the interior thereof.

31. The device according to claim 24, wherein the radiation-source generates a cylindrical-sector-shaped or cylindrical test-radiation bundle.

32. The device of claim 26 for use on a tubular object, wherein the bearing part and the radiation-source form a radiation head which is situated opposite the cassette with respect to the object.

33. The device of claim 32, further comprising: an image memory for at least two partially overlapping partial test images which have been recorded in two different peripheral positions of the testing head, and by an evaluating circuit which from the two test images removes portions, the relocation of which corresponds to a rotation with small spacing between radiation-source and axis of rotation.

34. The device according to claim 26, further comprising: one or more pressure-resistant housings which receive radiation-source, guide mechanism, read-out head and head-driving mechanism.

35. The device of claim 34, wherein the pressure-resistant housings have been filled with fluid under pressure, preferentially gas under pressure, preferentially inert gas under pressure.

36. The device according to claim 24, further comprising: an aligning instrument which responds if the radiation-source and read-out head are opposite one another, and which makes available an alignment-error signal depending on the spacing between radiation-source and a transducer unit.

37. The device according to claim 24, wherein the radiation-source generates a radiation fan, and a deflecting element is provided for the radiation fan.

38. The device of claim 37, wherein the fan-deflecting means and the head-driving mechanism are synchronised.

39. The device of claim 38, wherein the beam-deflecting instrument and the head-driving mechanism run with predetermined phase shift, and a recording layer extending along the surface of the object is provided.

40. The device of claim 39, wherein the phase shift is chosen with regard to the avoidance of a direct exposure of the read-out head to scattered test radiation.

41. The device of claim 40, wherein the fan-deflecting instrument and the head-driving mechanism run in phase, and the read-out head is directly capable of being exposed to radiation that has passed through the object.

42. The device of claim 37, wherein the head-driving mechanism and the fan-deflecting instrument are moved individually in succession.

43. The device according to claim 24, wherein the cassette is designed to be capable of being relocated on the object, and a cassette-position indicator is provided which makes available a cassette-position signal indicating a position of the cassette on the object.

44. The device of claim 43, wherein the cassette-position indicator exhibits a coarse-position sensor which co-operates with marks which are borne by the object.

45. The device of claim 44, wherein the cassette-position indicator exhibits a fine-position sensor which co-operates with the surface of the object frictionally, positively or optically.
